(19) United States
(12) Patent Application Publication
(10) Pub. No.: US 2016/0268633 A1
(43) Pub. Date: Sep. 15, 2016

(54) COPOLYMERS WITH A POLYACRYLIC ACID BACKBONE AS PERFORMANCE ENHANCERS FOR LITHIUM-ION CELLS

(71) Applicant: LUBRIZOL ADVANCED MATERIALS, INC., Cleveland, OH (US)

(72) Inventors: John D. Schofield, Bury (GB); Elliot Coulbeck, Bury (GB); Stuart N. Richards, Frodsham (GB); Patrick J. Sunderland, Rossendale (GB); Dean Thetford, Norden (GB)

(21) Appl. No.: 15/028,981

(22) PCT Filed: Oct. 10, 2014
(86) PCT No.: PCT/US2014/059994

§ 371 Date: Apr. 13, 2016

Related U.S. Application Data
(60) Provisional application No. 61/891,966, filed on Oct. 17, 2013.

(51) Int. Cl. H01M 10/0567; H01M 4/1397; H01M 4/133; H01M 4/1393; H01M 4/04; H01M 4/58; H01M 4/587; H01M 4/62; H01M 4/66; H01M 10/0525; H01M 10/0569; H01M 10/0568; H01M 2/16; H01M 10/0585; H01M 4/136

(52) U.S. Cl. CPC H01M 10/0567; H01M 4/136; H01M 4/1397; H01M 4/133; H01M 4/1393; H01M 4/0404; H01M 4/5825; H01M 4/587; H01M 4/623; H01M 4/625; H01M 4/661; H01M 10/0525; H01M 10/0569; H01M 10/0568; H01M 2/1653; H01M 10/0585; H01M 2004/027

(57) ABSTRACT

A polymeric polycarboxylic acid functionalized with polyether groups is disclosed as an additive to a lithium-ion battery to help improve properties such as energy density, cycle durability, or other durability issues.

### FIELD OF INVENTION

The disclosed technology relates to polymeric additives based on polyacrylic acid polymers as cell performance improvers for lithium-ion battery cells.

The disclosed technology, therefore, solves the problem of battery efficiency losses and capacity losses attributed to cycling and/or cycling at elevated temperatures.

### BACKGROUND OF THE INVENTION

Lithium secondary batteries, by virtue of the large reduction potential and low molecular weight of elemental lithium, offer a dramatic improvement in energy density over existing primary and secondary battery technologies. Lithium secondary batteries are batteries containing metallic lithium or atomic lithium as the negative electrode, also known as lithium-ion battery. By secondary battery it is meant a battery that provides for multiple cycles of charging and discharging. The small size and high mobility of lithium cations allow for the possibility of rapid recharging. These advantages make lithium-ion batteries ideal for portable electronic devices, e.g., cell phones and laptop computers. Recently, larger size lithium-ion batteries have been developed and have application for use in electric, hybrid, and plug-in hybrid vehicle market.

Concerns exist with lithium secondary batteries on optimizing cell energy density (to provide lighter and more efficient batteries), preventing pressurization of the battery from gaseous reaction products, preventing heating of the battery from cell resistance or chemical reactions, and maintaining cell energy density after numerous charge and discharge cycles at both ambient and elevated temperatures.

### SUMMARY OF THE INVENTION

The disclosed technology of providing electrolyte polymeric additive(s) to a lithium-ion battery to promote higher initial cell energy density, maintain cell energy density after repeated cycling, and or minimize side reactions that increase cell resistance or lower cell energy density are disclosed. One preferred electrolyte additive comprises a polyether functionalized polycarboxylic acid. A preferred polycarboxylic acid is a polycarboxylic acid derived from polymerizing free radically polymerizable monomers such as acrylic acid, methacrylic acid, maleic acid, fumaric acid, itaconic acid, mesaconic acid or citraconic acid optionally with up to 20 mole percent of other non-carboxylic acid containing monomers (such as acrylate, acrylonitrile, vinyl acetate, acrylamide, styrene, styrene sulfonic acid, 2-acrylamido-2-methylpropanesulfonic acid, vinylphosphonic acid, etc.).

Desirably, the polycarboxylic acid before functionalization with the polyether component has a molecular weight from about 700 g/mole to about 350,000 g/mole. Desirably, from about 5 to about 75 mole percent of the carboxylic acid groups of the polycarboxylic acid are reacted with hydroxy or amine terminated polyether moieties to create ester, amide, or imide linkages. Thus, about 25 to about 95 mole percent of the carboxylic acid groups are left in the acid form or neutralized with a counter ion, preferably Li⁺. The amine or hydroxyl terminated polyether desirably has from about 3 to about 80 alkylene oxide repeat units.

### DETAILED DESCRIPTION OF THE INVENTION

Various preferred features and embodiments will be described below by way of non-limiting illustration. Although we have used the term energy density because we have lower cell electrical resistivity in some of our examples, we also believe the same additive can provide improved power density under the correct circumstances. Thus, where we recite improved energy density we also allege that improved power density is often possible.

A battery may comprise one or more electrochemical cells; however, the terms battery and cell may be used interchangeably herein to mean a cell. Any reference to a voltage herein refers to voltage versus the lithium/lithium⁺ (Li/Li⁺) couple, unless otherwise stated. The lithium battery cell will refer to any combination of an anode, a cathode, an electrolyte, and an optional separator between the anode and the cathode which is porous to the electrolyte and Li⁺. Both the anode and the cathode are preferentially fabricated via a paste or coating optionally containing a solvent applied to a metal foil prior to or during cell fabrication. Said solvent may be organic, water or a mixture thereof. Desirably, the coating or paste used in the fabrication of the anode is compositionally different than the paste used in the fabrication of the cathode.

Types of lithium batteries include, but are not limited to, those with cathodes based on lithium cobalt oxide (LCO), lithium nickel oxide (LNO), lithium iron phosphate (LFP), lithium manganese oxide (LMO), lithium nickel manganese cobalt oxide (NMC), and lithium nickel cobalt aluminum oxide (NCA). Further optional doping elements in small amounts to the cathode include magnesium, manganese, titanium, zirconium, zinc, vanadium, aluminium. Types of lithium batteries furthermore include but are not limited to those with anodes based on metallic lithium, or those with anodes based upon materials into which lithium atoms can become intercalated or alloyed. Examples of such materials include carbonaceous materials, such as amorphous carbon or graphite (natural or artificial), tin, tin oxide, silicon, or germanium compounds and alloys thereof (such as tin cobalt alloys), metal oxides or derivatives of those materials (such as lithium titanate). When graphite is present it can be in the form of beads, flakes, fibres, and/or potatoes. When carbon is present it can be in any shape or size including mesocarbon microbead carbon, also known as MCBM. A preferred stoichiometry when lithium is intercalated into carbons such as graphite and the battery is in a fully charged state is LiC₆. A preferred stoichiometry when the anode is a lithium/silicon structure, and the battery is in a fully charged state is Li₁₅Si₄. Use of metallic lithium as the anode is often avoided because of its perceived hazards, these hazards often being associated with its tendency to form dendrites at the surface during repeated charge/discharge cycles.

The electrolyte comprises a source of lithium ions and optionally a solvent or carrier, solvent and/or carrier will be referred to collectively as solvent, to provide an electrolyte solution. In lithium polymer battery technology, the source of lithium ions is held in a solid polymer composite such as polyethylene oxide, poly(vinylidene fluoride), or polyacrylonitrile. This may optionally be swelled with a solvent, when it is often referred to as a polymer gel battery.

Inorganic sources of lithium ions can comprise one or more member of the group consisting of lithium hexafluorophosphate (LiPF₆), lithium bisoxalatoborate (LiBOB) as described in U.S. Pat. No. 6,924,066 B2 (hereby incorporated by reference), and other chelato-borate salts (e.g., Li difluorooxalatoborate, LiBF₂(C₂O₄), Li(C₂O₃CF₃)₂, LiBF₂(C₂O₃CF₃), and LiB(C₃H₂O₃(CF₃)₂)₂ as described in U.S. Pat. No. 6,407,232, EP 139532B1 and JP2005032716 A; (hereby incorporated by reference), lithium perchlorate (LiClO₄), lithium hexafluoroarsenate (LiAsF₆), lithium trifluoro-methanesulfonate (LiCF₃SO₃), lithium trifluoromethanesulfonimide (Li(CF3SO₂)₂N, lithium tetrafluoroborate (LiBF4), lithium tetrachloroaluminate (LiAlCl₄), and lithium hexafluoroantimonate (LiSbF₆). Additional sources of lithium ions include lithium bis(trifluoromethanesulfonyl) amide (LiN(CF₃SO₂)₂), lithium bis(glycolato)borate, lithium bis(lactato)borate, lithium bis(malonato)borate, lithium bis(salicylate)borate, lithium(glycolato, oxalato)borate, and combinations thereof.

The solvent or carrier may be an aprotic solvent. Typically, these aprotic solvents are anhydrous, forming anhydrous electrolyte solutions. By “anhydrous” it is meant that the solvent or carrier as well as the electrolyte comprises less than about 1,000 ppm water and normally less than about 500 to 100 ppm. Examples of aprotic solvents or carriers for forming the electrolyte solutions comprise at least one member selected from the group consisting of organic aprotic carriers or solvents such as: organic carbonates, esters, or ethers; their fluorinated derivatives; and mixtures thereof, among others. These include but are not limited to various cyclic alkylene carbonates, dialkyl carbonates, fluorinated dialkyl carbonates, and combinations thereof. These include ethylene carbonate (EC), propylene carbonate (PC), butylene carbonate (BC), fluoroethylene carbonate (FEC), difluoroethylene carbonate (DFEC), dimethyl carbonate (DMC), ethyl methyl carbonate (EMC), diethyl carbonate (DEC), methyl propyl carbonate (MPC), ethyl propyl carbonate (EPC), dipropyl carbonate (DPC), bis(trifluoroethyl) carbonate, bis(pentafluoropropyl) carbonate, trifluoroethyl methyl carbonate, pentafluoroethyl methyl carbonate, heptafluoropropyl methyl carbonate, perfluorobutyl methyl carbonate, trifluoroethyl ethyl carbonate, pentafluoroethyl ethyl carbonate, heptafluoropropyl ethyl carbonate, perfluorobutyl ethyl carbonate, vinylene carbonate (VC), vinylethylenecarbonate (VEC); among other carbonates, fluorinated oligomers, dimethoxyethane, triglyme, tetraglyme, tetraethyleneglycol, dimethyl ether (DME), polyethylene glycols, sulfones, and gamma-butyrolactone (GBL). Also included are so-called ionic liquids. These comprise a combination of an organic anion such as 1-ethyl-3-methylimidazolium, 1-butyl-3-methylimidazolium, N-methyl-N-propylpyrrolidinium, 1-butyl-1-methylpyrrolidinium, N-ethyl-N-propylpyrrolidinium, N-methyl-N-propylpiperidinium, 1-methyl-1-(2-methoxyethyl)pyrrolidinium or poly(diallydimethylammonium), and an organic cation such as bis(trifluoromethanesulphoyl)imide or bis(fluorosulphonyl)imide.

Both electrodes allow lithium ions to migrate towards and away from them. During insertion (or intercalation) ions move into the electrode. During the reverse process, extraction (or deintercalation), ions move back out. When a lithium-based cell is discharging the positive ion is extracted from the anode (usually graphite) and inserted into the cathode (lithium containing compound). When the cell is charging, the reverse occurs.

In some lithium-ion batteries (especially when the anode is carbon based, the electrolyte is a lithium salt, and the cathode is lithium metal oxide) the electrolyte reacts vigorously with the metallic or atomic lithium at the surface of the anode material (especially a carbon or silicon based anode material) during the initial formation charge and a thin passivating (solid electrolyte interface/interphase, hereinafter SEI) layer builds up between the anode and the electolyte and thereafter moderates the charge rate and restricts current. Additives that can facilitate the formation of the SEI passivation layers or subsequently stabilize the SEI passivation layer during use can comprise but are not limited to at least one member selected from the group consisting of chloroethylene carbonate, vinylene carbonate (VC), vinylethylenecarbonate (VEC), allyl ethyl carbonate, and non-carbonate species such as ethylene sulfite, propane sulfone, propylene sulfite, as well as substituted carbonates, sulfites and butyrolactones, such as phenylethylene carbonate, phenylvinylene carbonate, catechol carbonate, vinyl acetate, divinyl adipate, acrylonitrile, 2-vinyl pyridine, maleic anhydride, methyl cinnamate, vinylethylene carbonate, dimethyl sulfite, fluoroethylene carbonate, trifluoropropylene carbonate, bromo gamma-butyrolactone, and fluoro gamma-butyrolactone. Other additives include alkyl phosphite, vinyl silanes, cyclic alkyl sulphites, sulphur dioxide, polysulfides, nitrous oxide, alkyl or alkenyl nitrites and nitrates, halogenated cyclic lactones, methylchloroformate, lithium pyrocarbonate, carboxyl phenols, aromatic esters, succinimides, and N-substituted succinimides.

The additive or additives should be present in the electrolyte in an amount which achieves the optimum effect. In some embodiments, a single additive may be present in an amount between about 0.02 or 0.1 and about 5, 10 or 20 wt. % of the total weight of the electrolyte to be effective. In other aspects of the invention, two or more additives are present, each in an amount between about 0.02 or 0.1 to about 5 or 10% of the total weight of the electrolyte.

The battery or cell of this invention comprises any anode and cathode, a lithium salt containing electrolyte, and a polymeric additive that enhances battery performance. While not wishing to be bound by theory, it is theorized that the polymeric additive may facilitate the formation of a more desirable SEI passivation layer and/or may function by subsequently stabilizing the SEI passivation layer during use. Alternatively or additionally the polymeric additive may act as a scavenger and may remove or deactivate impurities formed during the charge and discharge process. The cathode for use in batteries of this invention may be based upon the cathode materials as earlier described in paragraph 0009 for lithium batteries. The anode materials are as described in paragraph 0009 for lithium batteries with the exception of lithium titanate. The lithium salt containing electrolyte of this invention are as described in paragraphs 0009 through 0012. Additional examples of suitable battery materials such as positive and negative electrode materials are described in patent application publication numbers JP 2007/258065A and US2007/0166609A 1; hereby incorporated by reference.

The optional separator for the lithium battery of this invention can comprise a micro porous polymer film. Examples of polymers for forming films comprise but are not limited to at least one member selected from the group consisting of nylon, cellulose, nitrocellulose, polysulfone, polyacrylonitrile, polyvinylidene fluoride, polyurethane, polypropylene, polyethylene, polybutene, mixtures thereof, among others. Ceramic separators, based on silicates, aluminio-silicates, and their derivatives, among others, may also be used. Surfactants may be added to the separator or electrolyte to improve electrolyte wetting of the separator. Other components or compounds known to be useful in electrolytes or cells may be added.

Alternatively a lithium-ion conductive polymer (such as poly(ethylene oxide) or polymer containing poly(ethylene oxide) blocks may be used together with an inorganic source of lithium ions. In this case, the solvent as heretofore described is optional. Such batteries may be called lithium polymer batteries or if swollen with solvent or plasticizer they may be called lithium polymer gel batteries. A separate separator between the anode and cathode is not required when a polymer layer carrying lithium ions exists between the anode and cathode.

The polymeric additive of this invention is a polyether functionalised polyacid. The polyacid comprises at least 80 mole %, more desirably at least 90 mole %, and more preferably at least 95 mole % of repeat units from free radically polymerizable unsaturated monomers with one or more carboxylic acid group (such as acrylic, methacrylic, maleic, fumaric, itaconic, mesaconic, or citraconic acids) of the structure —CH(A)-C(D)(B)—, and optionally up to 20 mole percent of repeat units of other free radically copolymerizable monomers other than those derived from monomers having carboxylic acid (such as acrylate, acrylonitrile, vinyl acetate, acrylamide, styrene, styrene sulfonic acid, 2-acrylamido-2-methylpropanesulfonic acid, vinylphosphonic acid, etc.); wherein the polyether functionalized polyacid comprises at least 80 weight % of repeat units of formula:

—[CH(A)-C(D)(B)]—

wherein:
A is H, —C(═O)— when an adjacent J is —N<, or B or mixtures thereof;
D is H, methyl, CH₂—B or a mixture thereof, especially H;
B is independently E, —C(═O)—, or G,

E is —CO₂H. E is optionally in a partial or full salt form, where the counterion is preferably a metal ion, especially a monovalent metal ion, especially a group 1 metal ion and especially lithium. The degree of salt formation is preferably as high as possible, as long as the polyether functionalised polyacid is soluble in the electrolyte.

When A is H; D is independently in each repeat unit H, CH₃ or —CH₂—B. When A is —C(═O)— or —C(═O)—OH; D is independently in each repeat unit H or CH₃.

G is CO-J-(C_{δ}H_{2δ}—O)_{L}—(CH₂CH₂O)_{M}—R₁, where δ is 3 and/or 4, the repeat units (C_{δ}H_{2δ}—O)_{L} and (CH₂CH₂O)_{M} may be in a random or block arrangement. G′ is G without the —CO— group (the polyether reactant without the —CO— group of the carboxylic acid) or -J-(C_{δ}H_{2δ}—O)_{L}—(CH₂CH₂O)_{M}—R₁
J is —O—, >N— when an adjacent A or B is —C(═O)—, or —N(H)—.
L is 0-20, especially 0-5, and especially 0.
M is 3-60, especially 5-25.

R₁ is a C₁-C₃₆ hydrocarbyl group, desirably C₁-C₁₈, especially C₁-C₄ which hydrocarbyl group can be a cyclic, branched or non-branched alkyl; aryl; alkylaryl or arylalkyl.

E:G or E:G′ in a number ratio is from 95:5 to 25:75, especially 80:20 to 50:50, and more especially 80:20 to 60:40

The number of repeat units in the polyacid is from 10-5000, desirably from 10 or 20 to 1000, and especially 20 to 100. The number average molecular weight of the polyacid before functionalization with the polyether is generally from about 700 to 350,000 g/mole, more desirably from about 1400 to 75,000 g/mole and preferably from about 1400 to 7,500 g/mole.

When J is NH, 0-100% of the NH can react with an adjacent —CO₂H or —C(═O)—O⁻ (defined by A or B) to give a five membered imide ring as shown below:
the repeat unit being of the structure

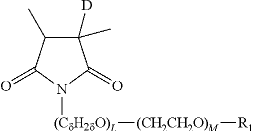

and/or with —CH₂—CO₂H or —CH₂—C(═O)—O⁻ (defined by Z) to give a five membered imide as shown below:
the repeat unit being of the structure

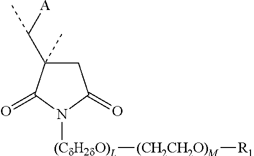

and/or two of adjacent repeat units from the polyacid might form a six membered imide ring when a nearby B is —CO₂H or —C(═O)—O⁻ and J is —N(H)— as shown below

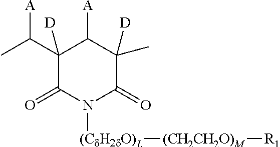

The polyether functionalized polycarboxylic acid may be prepared by processes known to a skilled person. For example, the polyether functionalized polycarboxylic acid may be prepared by esterification or amidation of polycarboxylic acid such as poly(meth)acrylic acid, or by polymerisation of (meth)acrylic acid with monosubstituted polyether esters and/or amides of (meth)acrylic acid.

The invention herein is useful for developing lithium-ion batteries with more capacity (higher energy density), and/or retention of capacity (energy density) and stability of cell internal electrical resistance after numerous charge and discharge cycles, which may be better understood with reference to the following examples.

### EXAMPLES

### List of Ingredients

Note all molecular weights used are number average molecular weights.
Carbosperse™ K752 polyacrylic acid of about 2000 molecular weight available from The Lubrizol Corporation, Wickliffe, Ohio
Polyacrylic acid of 2000 molecular weight and 62% active solution in water, ex Lubrizol.
Polyacrylic acid of 5000 molecular weight and 50% active solution in water, ex Lubrizol.
Poly(acrylic acid-co-maleic acid) of about 3000 molecular weight as 50% active in water available from Sigma Aldrich.
Polymethacrylic acid of about 3000 molecular weight as 35.4% active solution in water, ex Lubrizol.
Poly acrylic acid of about 1400 molecular weight as 45.6% active solution in water, ex Lubrizol.
Poly(acrylic-co-itaconic) acid of about 4700 molecular weight with a molar ratio 40 acrylic to 60 itaconic as a 45.6% active solution in water, ex Lubrizol.
Poly(ethylene glycol) monomethyl ether of about 350 molecular weight available from Sigma Aldrich.
Poly(ethylene glycol) monomethyl ether of about 500 molecular weight available from Ineos.
Poly(ethylene glycol) monomethyl ether of about 1000 molecular weight available from Ineos.
Poly(ethylene glycol) monomethyl ether of about 1100 molecular weight available from Sigma Aldrich.
Surfonamine™ L-100 from Huntsman, a polyether amine of molecular weight 1000
Surfonamine L200 from Huntsman, a polyether amine of molecular weight 2000
Surfonamine L207 from Huntsman, a polyether amine of molecular weight 2000
Polyether alcohol, consisting of Isofol™ 18T (carbon 18 branched alcohol) reacted with 10 equivalents of ethylene oxide, ex SASOL.
Lithium hydroxide monohydrate from Sigma Aldrich.
Lithium acetate dihydrate from Sigma Aldrich.
Distilled water, distilled in house using a Fistreem Cyclon distiller.
Ethylene carbonate from Sigma Aldrich
Ethyl methyl carbonate from Sigma Aldrich
Tetraglyme from Sigma Aldrich
4A molecular sieves from Sigma Aldrich as 8-12 mesh beads, these are activated before use at 300° C. under vacuum for a minimum of 3 hours,
Lithium nickel manganese cobalt oxide (LiNi_{0.5}Co_{0.2}Mn_{0.3}O₂),
Carbon black (grade: Super P Li, from Timcal)
Graphite (grade: MesoCarbon MicroBeads, D50=18 microns),
Microporous polypropylene separator membrane, Celgard® 3501
Lithium iron phosphate (such as grade: P2, from Sued Chemie or containing 3 wt. % carbon)
Polyvinylidene fluoride binder (such as grade: KYNAR™ ADX III, from Arkema)
Graphite (grade: TIMREX AF 261, from Timcal)
Lithium hexafluorophosphate, (grade LP40 from Merck)
Glass fibre separator membrane, (supplier: Whatman)
N-methyl-2-pyrrolidone (NMP).

### Intermediate 1

Carbosperse™ K752 (MW2000, ex Lubrizol, 63% active in water, 952 parts by weight) and poly(ethylene glycol) methyl ether (MW500, ex Ineos, 1470 parts) were charged to a reaction vessel and heated to 160° C. for 6 hours with a trap fitted and a nitrogen sparge. This gave a yellow liquid.

### Intermediate 2

Polyacrylic acid (MW2000, 62% active in water, 40.23 parts) was charged to a reaction flask. Lithium hydroxide monohydrate (0.52 parts) was dissolved in distilled water (5 parts) in a vial and then charged to the reaction flask. The vial was rinsed with distilled water (2 parts) and this was charged to reaction flask. The reaction mixture was heated to 70° C. under nitrogen and fitted with a condenser. After 3.5 hours warm poly(ethylene glycol) methyl ether (MW1100, 125.28, pre heated in 70° C. oven) was charged in 2 parts over 25 minutes, the temperature then was increased to 80° C. After a further 2 hours the temperature was increased to 120° C. and the condenser was exchanged for a trap. After a further 17.5 hours the temperature was increased to 130° C., after a further 4 hours the temperature was increased to 140° C. After a further 20 hours this gave a slightly cloudy material.

### Intermediate 3

Polyacrylic acid (MW2000, 62% active in water, 230.99 parts) along with poly(ethylene glycol) methyl ether (MW500, 331.51 parts) and lithium hydroxide monohydrate (3 parts) were charged to a reaction vessel fitted with a trap and heated from 25° C. to 120° C. under nitrogen. After 2 hours the temperature was increased to 140° C., after a further 4 hours the temperature was increased to 160° C. and stirred for 16 hours yielding a yellow liquid.

### Intermediate 4

Polyacrylic acid (MW2000, 62% active in water, 99.70 parts) along with poly(ethylene glycol) methyl ether (MW500, 71.54 parts) and lithium hydroxide monohydrate (1.30 parts) were charged to a reaction vessel fitted with a trap and heated from 25° C. to 120° C. under nitrogen. After 2 hours the temperature was increased to 140° C., after a further 2 hours the temperature was increased to 160° C. and stirred for 24 hours, tetraglyme (196.45 parts) was charged yielding a yellow liquid.

### Intermediate 5

Polyacrylic acid (MW2000, 62% active in water, 49.85 parts) along with poly(ethylene glycol) methyl ether (MW500, 85.86 parts) and lithium hydroxide monohydrate (0.65 parts) were charged to a reaction vessel fitted with a trap and heated from 25° C. to 120° C. under nitrogen. After 2 hours the temperature increased to 140° C., after a further 3½ hours the temperature was increased to 160° C. and the contents stirred for 17½ hours. Then the temperature was reduced to 120° C., after 2 hours tetraglyme (175.28 parts) was charged, this yielded a clear yellow liquid after 1 hour.

### Intermediate 6

Polyacrylic acid (MW2000, 62% active in water, 44.34 parts) and Surfonamine L-100 (127.27 parts, pre heated to 70° C. before addition) were charged to a reaction vessel fitted with a condenser and heated to 80° C. under nitrogen. After ½ hour the temperature was increased to 120° C. and the condenser was exchanged for a trap. After 2 hours temperature was increased to 140° C., after a further 1 hour the temperature was increased to 160° C. and the contents stirred for 16 hours. Then the temperature was reduced to 120° C., after 2 hours tetraglyme (232.14 parts) was charged, this yielded a brown liquid after 1 hour.

### Intermediate 7

Lithium hydroxide monohydrate (0.31 parts) was dissolved in distilled water (3 parts) in a vial, and then charged to a reaction vessel containing polyacrylic acid (MW2000, 62% active in water, 23.90 parts). The vial was then rinsed with distilled water and this was charged to the reaction vessel. The reaction mixture was heated to 70° C. under nitrogen in a flask fitted with a condenser. After 0.5 hour charged Surfonamine L-100 (6.86 parts) was charged to the reactor and after a further hour poly(ethylene glycol) monomethyl ether (MW1000, 61.74 parts) was charged. After 1 hour the condenser was exchanged for a trap and the temperature was increased to 120° C. After a further 1 hour the temperature was increased to 140° C. After a further 1½ hours the temperature was increased to 160° C. and the contents stirred for 17½ hours. Then the temperature was reduced to 120° C. After 1 hour tetraglyme (114.90 parts) was charged with stirring. This yielded a hazy liquid after 1 hour.

### Intermediate 8

Polyacrylic acid (MW5000, 50% active in water, 50.21 parts) along with poly(ethylene glycol) methyl ether (MW500, 58.11 parts) and lithium hydroxide monohydrate (0.53 parts) were charged to a reaction vessel fitted with a condenser and heated to 70° C. under nitrogen. After 1 hour the temperature was increased to 120° C. and the condenser was exchanged for a trap. After 2.5 hours the temperature was increased to 140° C., after a further 2 hours temperature increased to 160° C. and the contents were stirred for 17½ hours. Then the temperature was reduced to 120° C., after 1 hour tetraglyme (124.94 parts) was charged, this yielded a clear yellow liquid after 5 hours.

### Intermediate 9

Poly(acrylic acid-co-maleic acid) (MW3000, 50% active in water, 99.41 parts) and poly(ethylene glycol) methyl ether (MW500, 88.13 parts) were charged to a reaction vessel fitted with a condenser and heated to 70° C. under nitrogen.

After 1 hour the temperature was increased to 120° C. and the condenser was exchanged for a trap. After 1.5 hours the temperature was increased to 140° C., after a further 2½ hours the temperature was increased to 160° C. and the contents were stirred for 18 hours, this yielded a viscous brown liquid.

### Intermediate 10

Polymethacrylic acid (MW3000, 35.4% active in water, 99.51 parts) and poly(ethylene glycol) methyl ether (MW500, 68.21 parts) were charged to a reaction vessel fitted with a condenser and heated to 70° C. under nitrogen. After 2 hours the temperature was increased to 120° C. and the condenser was exchanged for a trap. After 2 hours the temperature was increased to 140° C., after a further 2 hours the temperature was increased to 160° C. and the contents were stirred for 16.5 hours, this yielded a cloudy liquid.

### Intermediate 11

Polyacrylic acid (MW2000, 62% active in water, 19.40 parts) and Surfonamine L207 (111.37 parts) were charged to a reaction vessel fitted with a condenser and heated to 70° C. under nitrogen. After 1 hour the temperature was increased to 120° C. and the condenser was exchanged for a trap. After 2 hours the temperature was increased to 140° C., after a further 2 hours the temperature was increased to 160° C. and the contents were stirred for 17 hours, this yielded a brown liquid.

### Intermediate 12

Polyacrylic acid (MW2000, 62% active in water, 87.86 parts) and poly(ethylene glycol) methyl ether (MW350, 88.27 parts) were charged to a reaction vessel fitted with a condenser and heated to 70° C. under nitrogen. After 0.5 hour the temperature was increased to 120° C. and the condenser was exchanged for a trap. After 2 hours the temperature was increased to 140° C., after a further 2 hours the temperature was increased to 160° C. and the contents were stirred for 17 hours, this yielded a clear yellow liquid.

### Intermediate 13

Polyacrylic acid (MW2000, 62% active in water, 43.15 parts) was charged to a reaction vessel fitted with a condenser and heated to 80° C. under nitrogen. After 1½ hours warm Surfonamine L200 (92.89 parts, this had been warmed to 70° C. before charging) was charged and the contents were stirred for 0.5 an hour. Then the temperature was increased to 130° C. and the condenser was exchanged for a trap. After 1.5 hour the temperature was increased to 140° C., after a further 6.5 hours this yielded a brown liquid that solidifies upon cooling.

### Intermediate 14

Polyacrylic acid (MW2000, 62% active in water, 49.88 parts) along with Polyether alcohol, consisting of Isofol 18T (carbon 18 branched alcohol) reacted with 10 equivalents of ethylene oxide (MW710, 101.65 parts), and lithium hydroxide monohydrate (0.65 parts) were charged to a reaction vessel fitted with a condenser and heated to 70° C. under nitrogen. After 1 hour the temperature was increased to 120° C. and the condenser was exchanged for a trap. After 2 hours the temperature was increased to 140° C., after a further 2 hours the temperature was increased to 160° C., after a further 16.5 hours this yielded a cloudy yellow liquid.

### Intermediate 15

Poly acrylic acid (MW1400, 61.6% active in water, 64.90 parts) along with poly(ethylene glycol) methyl ether (MW500, 92.54 parts) and lithium hydroxide monohydrate (0.84 parts) were charged to a reaction vessel fitted with a trap and heated to 120° C. After 2 hours the temperature was increased to 140° C., and after a further 1.5 hours the temperature was increased to 160° C. After a further 16 hours this yielded a yellow liquid.

### Intermediate 16

Poly(acrylic-co-itaconic) acid (MW4700, 45.6% active in water, 17.01 parts) and poly(ethylene glycol) methyl ether (MW500, 12.10 parts) were charged to a reaction vessel fitted with a condenser and heated to 70° C. under nitrogen. After 1 hour the temperature was increased to 120° C. and the condenser was exchanged for a trap. After 2 hours the temperature increased to 140° C., after a further 1.5 hours temperature increased to 160° C., and after a further 16 hours this yielded a brown viscous liquid

### Additive 1

Intermediate 1 (447.17 parts) was charged to a reaction flask and heated to 105° C. with stirring and a nitrogen sparge for 23 hours. The product was a viscous brown liquid, which had a water content of <0.1 wt. %.

### Additive 2

Intermediate 1 (70.97 parts) was charged to a reaction flask fitted with a condenser and heated with stirring to 50° C. under a nitrogen blanket. LiOH H₂O (ex Sigma-Aldrich, 4.27 parts) was dissolved in distilled water (30 parts) and then charged to the reaction flask. Water (5 parts) was used to rinse the dissolving vessel and this was then also added to the reaction mixture. The reaction mixture was then heated to 70° C. and stirred for 2 hours. The condenser was then replaced with a trap and the reaction mixture was heated to 110° C. and stirred for 20 hours. The product was a yellow viscous liquid.

### Additive 3

Carbosperse K752 (MW2000, ex Lubrizol, 63% active in water, 237.27 parts) and poly(ethylene glycol) methyl ether (MW500, ex Ineos, 345.67 parts) were charged to a reaction vessel fitted with a trap, heated to 120° C. under nitrogen, and stirred for 1.5 hours. The temperature was then increased to 160° C. for 15.5 hours. The reaction mixture was then cooled to 50° C., the trap was replaced with a condenser and a nitrogen sparge was added. LiOH H₂O (ex Sigma-Aldrich, 29 parts) was dissolved in distilled water (170 parts) and then charged to the reaction flask. Water (25 parts) was used to rinse the dissolving vessel out and this was then also added to the reaction mixture. The reaction mixture was heated to 70° C. and stirred for 3 hours. The condenser was then exchanged for a trap. The reaction mixture was heated to 115° C. and stirred for 75.5 hours. The product was a viscous brown liquid, which had a water content of 520 ppm.

### Additive 4

Intermediate 2 (48.95 parts) was heated to 50° C. under nitrogen in a reaction flask fitted with a condenser. Lithium hydroxide monohydrate (1.42 parts) was dissolved in distilled water (22 parts) in a vial and added to the reaction mixture. The vial was rinsed with distilled water (5 parts) and the water was charged to the reaction mixture. The temperature was increased to 70° C. in the reaction vessel. After 1 hour the condenser was replaced with a trap and the reaction temperature increased to 115° C. After a further 3.5 hours the trap was removed and the temperature was increased to 120° C. After a further 17 hours the temperature was reduced to 70° C. and a condenser was fitted to the flask, when at 70° C. ethylene carbonate (22.67 parts) was charged to the flask. After a further 1 hour ethyl methyl carbonate (52.89 parts) was charged to the flask. After a further 1 hour this yielded a cloudy liquid.

The liquid was dried by heating the reaction mixture to 70° C. and 4A molecular sieves (20% by weight of reaction mixture) were charged, and the contents stirred for 5.5 hours at 70° C., then the contents were cooled to room temperature and stirred for 15 hours. Then the contents were reheated to 70° C. for 7½ hours. The liquid part of this mixture was filtered through a 0.45 um syringe filter, yielding a cloudy liquid.

### Additive 5

Intermediate 3 (53.27 parts) and tetraglyme (80.53 parts) were charged to a reaction vessel fitted with a condenser and heated to 70° C. under nitrogen. After 0.5 hour lithium hydroxide monohydrate (2.88 parts) was dissolved in distilled water (25 parts) in a vial and then charged this to the reaction vessel. The vial was rinsed with distilled water (5 parts) and the water was charged this to the reaction vessel. After a further 2 hours of stirring the condenser was replaced with a trap and the temperature was increased to 120° C. After a further 3.75 hours the trap was removed and the nitrogen flow was increased, the contents were stirred for a further 18 hours, which yielded a pale clear liquid.

The liquid was dried by stirring at 140° C. with a nitrogen sparge for 29 hours, and then charged to a jar containing 4A molecular sieves (10% by weight of reaction mixture).

### Additive 6

Intermediate 3 (23.47 parts), tetraglyme (35.75 parts) and lithium acetate dihydrate (6.17 parts) were charged to a reaction vessel and heated to 80° C. under nitrogen with 1 port open. After 4 hours the temperature was increased to 120° C. After a further 20 hours the temperature was reduced to 80° C. After a further 2 hours distilled water (6 parts) was charged and a condenser was fitted to the flask. After a further 4 hours the temperature was increased to 120° C. and the condenser was removed. After a further 18 hours at 120° C. a clear liquid was yielded.

The liquid was dried by stirring at 140° C. with a nitrogen sparge for 28 hours, and then charged to a jar containing 4A molecular sieves (10% by weight of reaction mixture).

### Additive 7

Intermediate 4 (127.05 parts) and lithium acetate dihydrate (13.33 parts) were charged to a reaction vessel fitted with a condenser and heated to 80° C. under nitrogen. After 1 hour distilled water (12 parts) was charged. After a further 3 hours the temperature was increased to 120° C. and the condenser was exchanged for a trap. After a further 18 hours at 120° C. a clear liquid was yielded.

The liquid was dried by stirring at 140° C. with a nitrogen sparge for 28 hours, and then charged to a jar containing 4A molecular sieves (10% by weight of reaction mixture).

### Additive 8

Intermediate 5 (101.82 parts) and lithium acetate dihydrate (4.42 parts) were charged to a reaction vessel fitted with a condenser and heated to 80° C. under nitrogen. After 1 hour distilled water (10 parts) was charged. After a further 1 hour the temperature was increased to 120° C. and the condenser was exchanged for a trap. After a further 17 hours at 120° C. a clear liquid was yielded.

The liquid was dried by stirring at 140° C. with a nitrogen sparge for 21 hours, and then charged to a jar containing 4A molecular sieves (10% by weight of reaction mixture).

### Additive 9

Intermediate 6 (104.78 parts) and lithium acetate dihydrate (3.57 parts) were charged to a reaction vessel fitted with a condenser and heated to 80° C. under nitrogen. After 1 hour distilled water (10 parts) was charged. After a further 1 hour the temperature was increased to 120° C. and the condenser was exchanged for a trap. After a further 17 hours at 120° C. a clear liquid was yielded.

The liquid was dried by stirring at 140° C. with a nitrogen sparge for 21 hours, and then charged to a jar containing 4A molecular sieves (10% by weight of reaction mixture).

### Additive 10

Intermediate 7 (69.85 parts) along with lithium acetate dihydrate (2.38 parts) and distilled water (4 parts) were charged to a reaction vessel fitted with a condenser and heated to 80° C. under nitrogen. After 1 hour the temperature was increased to 120° C. and the condenser was exchanged for a trap. After a further 22.5 hours at 120° C. a cloudy liquid was yielded.

The liquid was dried by stirring at 140° C. with a nitrogen sparge for 24 hours, and then charged to a jar containing 4A molecular sieves (10% by weight of reaction mixture).

### Additive 11

Intermediate 8 (106.04 parts) along with lithium acetate dihydrate (6.20 parts) and distilled water (10 parts) were charged to a reaction vessel fitted with a condenser and heated to 80° C. under nitrogen. After 1½ hours the temperature was increased to 120° C. and the condenser was exchanged for a trap. After a further 22 hours at 120° C. a clear liquid was yielded.

The liquid was dried by stirring at 140° C. with a nitrogen sparge for 24 hours, and then charged to a jar containing 4A molecular sieves (10% by weight of reaction mixture). The above procedure of drying for 24 hours at 140° C. with nitrogen sparge and then storing with 4A molecular sieves is called a proposed drying procedure. This is the last sample actually dried and tested. It is proposed that Additives 12-19 would also be dried by a similar procedure to the proposed drying procedure before being tested.

### Additive 12

Intermediate 9 (57.16 parts) was heated to 70° C. under nitrogen in a vessel fitted with a condenser. Tetraglyme (86.92 parts) was charged and the contents were stirred for 1 hour at 70° C. Lithium acetate dihydrate (13.36 parts) and distilled water (20 parts) were charged and the contents were stirred for 1 hour. Then the temperature was increased to 120° C., the condenser was replaced with a trap, and the contents were stirred for 19 hours yielding a clear brown liquid.

### Additive 13

Intermediate 10 (40.34 parts) and tetraglyme (61.00 parts) were heated to 70° C. under nitrogen in a reaction vessel fitted with a condenser. After 2 hours the temperature was increased to 120° C. and the contents were stirred for 3 hours. The temperature was reduced to 70° C., then lithium acetate dihydrate (5.56 parts) and distilled water (10 parts) were charged and the contents were stirred for 1 hour. Then the temperature was increased to 120° C., the condenser was replaced with a trap, and the contents were stirred for 22 hours yielding a slightly cloudy liquid.

### Additive 14

Intermediate 11 (52.43 parts) and tetraglyme (78.86 parts) were heated to 70° C. under nitrogen in a reaction vessel fitted with a condenser. After 2 hours lithium acetate dihydrate (2.43 parts) and distilled water (5 parts) were charged and the contents were stirred for 1.5 hours. Then the temperature was increased to 120° C. and the condenser was replaced with a trap and the contents were stirred for 19½ hours yielding a clear orange liquid.

### Additive 15

Intermediate 12 (49.97 parts) and tetraglyme (75.78 parts) were heated to 70° C. under nitrogen in a reaction vessel fitted with a condenser. After 2 hours lithium acetate dihydrate (9.30 parts) and distilled water (10 parts) were charged and the contents were stirred for 1.5 hours. Then the temperature was increased to 120° C. and the condenser was replaced with a trap and the contents were stirred for 19½ hours yielding a clear liquid.

### Additive 16

Intermediate 13 (54.06 parts) and tetraglyme (81.76 parts) were heated to 70° C. under nitrogen in a reaction vessel fitted with a condenser. After 1 hour lithium acetate dihydrate (7.55 parts) and distilled water (10 parts) were charged and the contents were stirred for 1 hour. Then the temperature was increased to 120° C. and the condenser was replaced with a trap and the contents were stirred for 19 hours yielding orange liquid, which goes solid upon standing.

### Additive 17

Intermediate 14 (75.04 parts) and tetraglyme (113.30 parts) were heated to 70° C. under nitrogen in a reaction vessel fitted with a condenser. After 1 hour lithium acetate dihydrate (8.43 parts) and distilled water (10 parts) were charged and the contents stirred for 1 hour. Then the temperature was increased to 120° C. and the condenser was replaced with a trap and the contents were stirred for 21 hours yielding a cloudy liquid.

### Additive 18

Intermediate 15 (61.61 parts) and tetraglyme (93.21 parts) were heated to 70° C. under nitrogen in a reaction vessel fitted with a condenser. After 1 hour lithium acetate dihydrate (9.00 parts) and distilled water (10 parts) were charged and the contents were stirred for 1 hour. Then the temperature was increased to 120° C. and the condenser was replaced with a trap and the contents were stirred for 21 hours yielding a clear yellow liquid.

### Additive 19

Intermediate 16 (11.46 parts) and tetraglyme (17.32 parts) were heated to 70° C. under nitrogen in a reaction vessel fitted with a condenser. After 3 hours the temperature was increased to 120° C. for 3 hours. Then the temperature was reduced to 70° C., lithium acetate dihydrate (1.46 parts) and distilled water (3 parts) were charged, and the contents were stirred for 1 hour. Then the temperature was increased to 120° C. and the condenser was replaced with a trap and the contents were stirred for 22 hours yielding a brown liquid.

### Comparative Cell Examples 1.1, 1.2, 1.3, 1.4, 1.5, 1.6 and 1.7

### Coin Type Cells

These Cells were fabricated from the following components:

A cathode comprising a copper foil current collector coated with the electroactive layer; which contained lithium iron phosphate (containing 3% carbon), carbon black (grade: Super P Li, from Timcal) and polyvinylidene fluoride binder. The coating was applied from a dispersion in N-methyl-2-pyrrolidone (NMP).

An anode comprising an aluminum foil current collector coated with the electroactive layer; which contained graphite (grade: MesoCarbon MicroBeads, D₅₀=18 microns), carbon black (grade: Super P Li, from Timcal) and polyvinylidene fluoride binder. The coating was applied from a dispersion in NMP.

An electrolyte comprising a mixture of ethylene carbonate and ethyl methyl carbonate in a 3:7 weight ratio, which contains in solution 1.2M lithium hexafluorophosphate.

A micro porous polypropylene separator membrane, Celgard® 3501 The Cells were assembled as coin cells, type CR2016, with an electrode surface area of approximately 1 cm².

### Comparative Cell Example 2

### Coffee Bag Type Cell

This cell was fabricated from the following components:

1. A cathode comprising a copper foil current collector coated with the electroactive layer which contained 80 parts lithium iron phosphate (grade: P2, from Sued Chemie) and 13 parts polyvinylidene fluoride binder (grade: KYNAR ADX III, from Arkema) and 7 parts carbon black (grade: Super P Li, from Timcal). The coating was applied from a dispersion in NMP
2. An anode comprising an aluminum foil current collector coated with the electroactive layer which contained 84.5 parts graphite (grade: TIMREX AF 261, from Timcal) and 13 parts polyvinylidene fluoride binder (grade: KYNAR ADX III, from Arkema). The coating was applied from a dispersion in NMP.
3. An electrolyte comprising a mixture of ethylene carbonate and diethyl carbonate in a 1:1 weight ratio, which contains in solution 1M lithium hexafluorophosphate, (grade LP40 from Merck)
4. A glass fibre separator membrane, (supplier: Whatman)
The Cells were assembled as pouch or “coffee bag” cells, with an electrode surface area of approximately 4 cm².

### Comparative Cell Example 3

### Pouch Type

1. The cathode was fabricated as per Comparative Example 1
2. The anode was fabricated as per Comparative Example 1
3. The electrolyte was of the same formulation as in Comparative Example 1
4. The cell had a separator membrane of the type used in Comparative Example 1.
The Cells were assembled as pouch type cells (but significantly larger than in Comparative Example 2). The anode and cathode had the approximate dimensions of 7.8 by 5.3 mm, and the pouch cell had the external dimensions of 8.5 by 6.7 mm. The cell was filled with 2.20 g of electrolyte under dry conditions, then the cell was evacuated under vacuum to remove any gases.

### Comparative Example 4

### Coin Type Cell

This cell was fabricated from the following components:

A cathode comprised a copper foil current collector coated with an electroactive layer which contained lithium nickel manganese cobalt oxide (LiNi_{0.5}Co_{0.2}Mn_{0.3}O₂), carbon black (grade: Super P Li, from Timcal) and polyvinylidene fluoride binder.
The coating was applied from a dispersion in N-methyl-2-pyrrolidone (NMP).
The anode was fabricated as per Comparative Example 1.
The electrolyte is of the same formulation as in Comparative Example 1.
The cell had a separator membrane of the type used in Comparative Example 1.

### Cell Examples 1.1 to 7.1, 1.2 to 7.2, 9 to 16 and 18

### Coin Type Cell

These were fabricated as per Comparative Cell Example 1, except that an Additive was dissolved in the electrolyte prior to fabrication of the Cell. The specific additives and the weights used are shown in Table 1.

TABLE 1

| | | Weight (mg) | Weight (mg) | Weight (mg) |
|---|---|---|---|---|
| Cell Example | Additive | of electrolyte | of graphite | of Additive |
| No. | added | used in cell | used in cell | used in cell |
| 1.1 and 1.2 | 1 | 280 | 3.4 | 0. |
| 2.1 and 2.2 | 1 | 280 | 3.4 | 0.7 |
| 3.1 and 3.2 | 2 | 280 | 3.4 | 0.7 |
| 4.1 and 4.2 | 2 | 280 | 3.4 | 0.7 |
| 5.1 and 5.2 | 3 | 280 | 3.4 | 0.35 |
| 6.1 and 6.2 | 3 | 280 | 3.4 | 0.7 |
| 7.1 and 7.2 | 3 | 280 | 3.4 | 1.4 |
| 9 | 4 | 280 | 3.4 | 1.75 |
| 10 | 5 | 280 | 3.4 | 1.75 |
| 11 | 6 | 280 | 3.4 | 1.75 |
| 12 | 7 | 280 | 3.4 | 1.75 |
| 13 | 8 | 280 | 3.4 | 1.75 |
| 14 | 9 | 280 | 3.4 | 1.75 |
| 15 | 10 | 280 | 3.4 | 1.75 |
| 16 | 11 | 280 | 3.4 | 1.75 |
| 18 | 3 | 280 | 3.4 | 0.7 |

### Cell Example 8

### Coffee Bag Type Cell

These were fabricated as per Comparative Cell Example 2, except that 2.5 parts Additive 1 was dissolved in the NMP prior to coating of the anode. The relative amount for NMP was also reduced by about 25%.

### Cell Example 17

### Pouch Type Cell

This was fabricated as per Comparative example 3, except that 110 mg. of Additive 5 were dissolved in the electrolyte prior to filling the cell.

### Cell Example 19

### Coin Type Cell

This was fabricated as per Comparative Example 4, except that 1.75 mg. of Additive 5 were dissolved in the electrolyte prior to filling the cell. Results are in Table 13.

Cell Testing Protocol 1 (Room Temperature. Around 25° C.) (Coin Type Cell)
1. Activate cell with 3 charge/discharge cycles at a rate of 0.1C.
2. Test cycling of cell for desired number of cycles using these charge/discharge conditions.
1. Charge at a constant 1.0C current up to 3.60V.
2. Continue to charge, but at constant 3.60 V potential until current drops to 0.02 V.
3. Rest for 5 min.
4. Discharge at constant 1.0C current down to 2.00 V
5. Rest for 5 min.
All cells are made and tested in triplicate. Results reported below are normally the average of the 3 cells. Results are shown in Tables 2, 3, 4, 5, 6 and 7.

TABLE 2

| | Initial | | | | |
|---|---|---|---|---|---|
| | Specific | Specific | Specific | % Ca- | % Ca- |
| Cell | Capacity | Capacity | Capacity | pacity | pacity |
| Example or | after | after 300 | after 520 | retention | retention |
| comparative | activation | cycles | cycles | after 300 | after 520 |
| example No. | (mAh/g) | (mAh/g) | (mAh/g) | cycles | cycles |
| Comp. Ex. | 126.75 | 106.82 | 95.29 | 84.27 | 75.18 |
| 1.1 | | | | | |
| Comp. Ex. | 127.54 | 104.58 | — | 82.00 | — |
| 1.2 | | | | | |
| Example 1.1 | 139.40 | 124.60 | 117.09 | 89.38 | 83.99 |
| Example 2.1 | 132.23 | 109.12 | — | 82.52 | — |
| Example 3.1 | 142.37 | 127.99 | 121.98 | 89.90 | 85.67 |
| Example 4.1 | 136.44 | 118.12 | — | 86.57 | — |
| Example 5.1 | 129.23 | 110.54 | — | 85.53 | — |
| Example 6.1 | 133.88 | 115.99 | — | 86.64 | — |
| Example 7.1 | 131.16 | 110.28 | — | 84.08 | — |

TABLE 3

| | Initial | | |
|---|---|---|---|
| | Specific | Specific | % Ca- |
| Cell | Capacity | Capacity | pacity |
| Example or | after | after 1100 | retention |
| comparative | activation | cycles | after 1100 |
| example No. | (mAh/g) | (mAh/g) | cycles |
| Comp. Ex. | 124.71 | 78.95 | 63.1 |
| 1.5 | | | |
| Example 9 | 127.32 | 91.52 | 71.8 |

TABLE 4

| | Initial | | | | |
|---|---|---|---|---|---|
| | Specific | Specific | Specific | % Ca- | % Ca- |
| Cell | Capacity | Capacity | Capacity | pacity | pacity |
| Example or | after | after 300 | after 780 | retention | retention |
| comparative | activation | cycles | cycles | after 300 | after 780 |
| example No. | (mAh/g) | (mAh/g) | (mAh/g) | cycles | cycles |
| Comp. Ex. | 124.82 | 104.66 | 93.99 | 83.84 | 75.30 |
| 1.6 | | | | | |
| Example 10 | 118.79 | 110.52 | 100.04 | 93.03 | 84.21 |

TABLE 5

| | Initial | | | | |
|---|---|---|---|---|---|
| | Specific | Specific | Specific | % Ca- | % Ca- |
| Cell | Capacity | Capacity | Capacity | pacity | pacity |
| Example or | after | after 300 | after 450 | retention | retention |
| comparative | activation | cycles | cycles | after 300 | after 450 |
| example No. | (mAh/g) | (mAh/g) | (mAh/g) | cycles | cycles |
| Comp. Ex. | 124.82 | 104.66 | 100.80 | 83.84 | 80.75 |
| 1.6 | | | | | |
| Example 11 | 117.22 | 106.47 | 101.30 | 90.83 | 86.41 |
| Example 12 | 116.15 | 104.47 | 98.93 | 89.95 | 85.17 |
| Example 13 | 120.85 | 113.15 | 109.76 | 93.62 | 90.82 |
| Example 14 | 114.01 | 103.07 | 98.27 | 90.40 | 86.19 |

TABLE 6

| | Initial | | |
|---|---|---|---|
| | Specific | Specific | % Ca- |
| Cell | Capacity | Capacity | pacity |
| Example or | after | after 100 | retention |
| comparative | activation | cycles | after 100 |
| example No. | (mAh/g) | (mAh/g) | cycles |
| Comp. Ex. | 124.82 | 113.59 | 91.00 |
| 1.6 | | | |
| Example 15 | 117.18 | 108.97 | 92.96 |
| Example 16 | 125.64 | 122.30 | 97.25 |

TABLE 7
(Pouch Cells)

| | Initial | | | | |
|---|---|---|---|---|---|
| | Specific | Specific | Specific | % Ca- | % Ca- |
| Cell | Capacity | Capacity | Capacity | pacity | pacity |
| Example or | after | after 300 | after 750 | retention | retention |
| comparative | activation | cycles | cycles | after 300 | after 750 |
| example No. | (mAh/g) | (mAh/g) | (mAh/g) | cycles | cycles |
| Comp. Ex. | 116.55 | 96.43 | 82.30 | 82.74 | 70.61 |
| 3 | | | | | |
| Example 17 | 116.02 | 107.10 | 95.60 | 92.31 | 82.40 |

### Cell Testing Protocol 2 (High Temperature) (Coin Type Cell)

This is identical to Cell Testing Protocol 1, except that the test cycling is carried out at 60° C. The results are shown in Table 8.

TABLE 8

| | Number of cycles | % Ca- |
|---|---|---|
| Cell | after which | pacity |
| Example or | capacity drops | retention |
| comparative | below 80% of | after 100 |
| example No. | initial capacity | cycles |
| Comp. Ex. | 14 | 13.85 |
| 1.3 | | |
| Comp. Ex. | 16 | 14.99 |
| 1.4 | | |
| Example 1.2 | 16 | 15.58 |
| Example 2.2 | 17 | 19.46 |
| Example 3.2 | 25 | 40.42 |
| Example 4.2 | 25 | 40.47 |
| Example 5.2 | 18 | 24.42 |
| Example 6.2 | 23 | 36.75 |
| Example 7.2 | 18 | 26.38 |

### Cell Testing Protocol 3 (Room Temperature, Around 25° C.) (Coffee Bag Type Cell)

1. Activate cell with 3 charge/discharge cycles at a rate of 0.1C
2. Test cycling of cell for 90 cycles using these charge/discharge conditions
1. Charge at constant 2 mA current to up 3.65 V

### 2. Rest

3. Discharge at constant 2 mA current down to 2.00 V

### 4. Rest

The results are shown in Table 9.

TABLE 9

| | Specific | Specific | Specific | |
|---|---|---|---|---|
| | Capacity | Capacity | Capacity | |
| | after 1^{st} | after 2^{nd} | after 3^{rd} | % Ca- |
| Cell | activation | activation | activation | pacity |
| Example or | charging | charging | charging | retention |
| comparative | cycle | cycle | cycle | after 90 |
| example No. | (mAh/g) | (mAh/g) | (mAh/g) | cycles |
| Comp. Ex. | 158.5 | 100.1 | 97.1 | 83.9% |
| 2 | | | | |
| Example 8 | 153.8 | 130.8 | 126.5 | 89.0% |

### Cell Testing Protocol 4 Electrochemical Impedance Spectroscopy (EIS) (Coin Type Cell)

The cell was operated as in Cell Testing Protocol 1, with EIS spectra being obtained before or after the charging cycle indicated. The EIS spectra were obtained at a voltage of 5 mV, scanning between frequencies of 1 MHz and 0.01 Hz. This fitting model was then used to determine R_{SEI} and R_{O}.

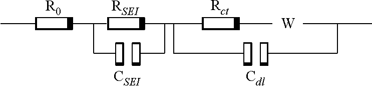

R_{O}: contact resistance
R_{SEI}: resistance of the electrode material
C_{SEI}: capacitance of the electrode material
R_{ct}: charge transfer resistance
C_{dl}: capacitance of double layer
W: Warburg element

Appropriate values of the Charge Transfer Resistance, the Capacitance of the Electrode Material, the Capacitance of the Double Layer and Warburg Element were used in the fitting process. The results are shown in Tables 10 and 11.

TABLE 10
Calculated R_{SEI} values (ohms)

| Cell | | | | |
|---|---|---|---|---|
| Example or | | | | |
| Comparative | | | | |
| Example No. | 1^{st} Cycle | 100^{th} Cycle | 200^{th} Cycle | 300^{th} Cycle |
| Comp. Ex. | 11.8 | 15.8 | 21.4 | 28.8 |
| 1.2 | | | | |
| Example 4.1 | 10.2 | 10.4 | 10.2 | 10.5 |
| Example 6.1 | 9.7 | 10.3 | 10.7 | 10.5 |

TABLE 11
Calculated R_{O} values (ohms)

| Cell | | | | |
|---|---|---|---|---|
| Example or | | | | |
| Comparative | | | | |
| Example No. | 1^{st} Cycle | 100^{th} Cycle | 200^{th} Cycle | 300^{th} Cycle |
| Comp. Ex. | 5.6 | 9.1 | 15.7 | 21.0 |
| 1.2 | | | | |
| Example 4.1 | 3.2 | 2.8 | 2.8 | 2.8 |
| Example 6.1 | 3.3 | 3.1 | 2.8 | 3.0 |

### Cell Testing Protocol 5 First Cycle Discharge Curves (Coin Cell and Pouch Cell)

1. Activate cell with 3 charge/discharge cycles at a rate of 0.1C.
2. Charge at constant current indicated in Table 7 up to 3.60 V
3. Continue to charge, but at constant 3.60 V potential until current drops to 0.02 V

### 4. Rest for 5 min.

5. Discharge at same constant current down to 2.00 V

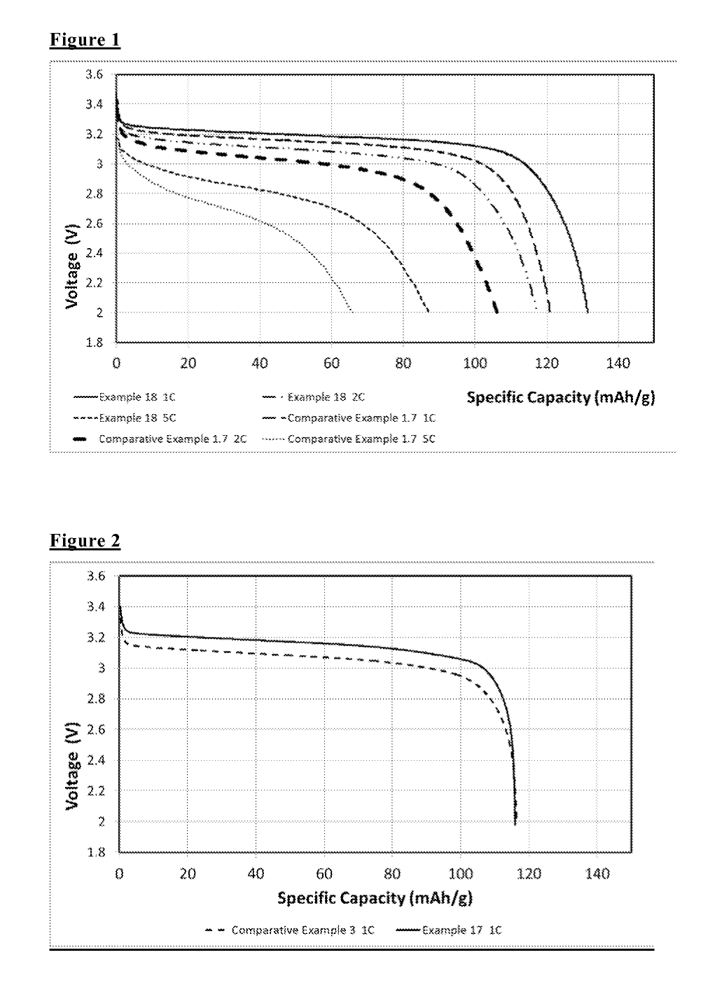

FIG. 1 (Coin cells) shows the First Cycle discharge curves (Voltage versus accumulated Specific Capacity) for Comparative Example 1.7, and Example 18.

FIG. 2 (Pouch cells) shows the First Cycle discharge curves (Voltage versus accumulated Specific Capacity) for Comparative Example 3, and Example 17.

Specific Energies (mWh/g) can be calculated from these First Cycle Discharge Curves by summing the multiple of each incremental increase in Specific Capacity (mAh/g) and the Discharge Voltage (V) at that point. Table 12 shows these Specific Energies.

TABLE 12

| | Comparative | | Comparative | |
|---|---|---|---|---|
| Discharge | Example 1.7 | Example 18 | Example 3 | Example 17 |
| Current | mWh/g | mWh/g | mWh/g | mWh/g |
| 1 C | 372.2 | 408.8 | 352.9 | 362.9 |
| 2 C | 310.8 | 352.8 | — | — |
| 5 C | 173.5 | 238.5 | — | — |

### Cell Testing Protocol 6 (Room Temperature, Around 25° C.) (Coin Type Cell)

This is carried out as per Cell Testing Protocol 1, except that the cell is charged up to 4.6V, and discharged down to 2.8V. Results are shown in Table 13.

TABLE 13

| | Initial | | |
|---|---|---|---|
| | Specific | Specific | % Ca- |
| Cell | Capacity | Capacity | pacity |
| Example or | after | after 100 | retention |
| comparative | activation | cycles | after 100 |
| example No. | (mAh/g) | (mAh/g) | cycles |
| Comp. Ex. | 151.24 | 136.64 | 90.44 |
| 4 | | | |
| Example 19 | 151.97 | 142.19 | 93.51 |

Each of the documents referred to above is incorporated herein by reference, including any prior applications, whether or not specifically listed above, from which priority is claimed. The mention of any document is not an admission that such document qualifies as prior art or constitutes the general knowledge of the skilled person in any jurisdiction. Except in the Examples, or where otherwise explicitly indicated, all numerical quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the invention can be used together with ranges or amounts for any of the other elements.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the essential or basic and novel characteristics of the composition or method under consideration.

While certain representative embodiments and details have been shown for the purpose of illustrating the subject invention, it will be apparent to those skilled in this art that various changes and modifications can be made therein without departing from the scope of the subject invention. In this regard, the scope of the invention is to be limited only by the following claims.

What is claimed is:

1. A lithium-ion battery cell of the type that is capable of multiple charging and discharging cycles, said battery comprising
an anode,
a cathode,
lithium salt electrolyte in an organic solvent, or carrier, or polymer or combinations thereof,
optionally a separator between the anode and cathode that is porous to the lithium salt electrolyte,
and from about 0.02 to about 20 weight percent of a polyether functionalized polycarboxylic acid having a polycarboxylic acid portion and a polyether portion, said polycarboxylic acid portion derived from polymerizing unsaturated monomers having one or more carboxylic acid group through their carbon to carbon unsaturation and having a molecular weight from about 700 to about 350,000 g/mole wherein from about 5 to 75 mole percent of the carboxylic acid groups of said polycarboxylic acid have been converted to ester, amide, or imide linkages from reaction of the carboxylic acid groups with hydroxyl or amine terminated polyethers having from 3 to 80 ether repeat units each, wherein said hydroxyl or amine terminated polyethers form the polyether portion of said polyether functionalized polycarboxylic acid when reacted with carboxylic acid groups of said polycarboxylic acid, and wherein said weight percent is based on the weight of said electrolyte.

2. The lithium-ion battery cell according to claim 1, wherein said polycarboxylic acid has repeating units and at least 80 mole percent of the repeating units in said polycarboxylic acid are derived from polymerizing unsaturated monomers having functional groups selected from monocarboxylic acid, dicarboxylic acid, and anhydride of dicarboxylic acid and form repeat units with monocarboxylic acid, dicarboxylic acid, anhydride of dicarboxylic acid or mixtures thereof.

3. The lithium-ion battery cell according to claim 2, wherein the number of repeating units in said polycarboxylic acid from unsaturated monomers having monocarboxylic acid, dicarboxylic acid and anhydride of dicarboxylic acid is from about 10 to about 1000.

4. The lithium-ion battery cell according to claim 3, wherein said polyether portion is comprised of terminal C₁₋₃₆ hydrocarbyl groups; connecting groups between the carboxylic acid portion and the polyether portion selected from —N(H)—, —N< and —O—; and repeat units in the polyether portion selected from the group of —C₂H₄—O—, —C₃H₆—O—, and —C₄H₈—O—.

5. The lithium-ion battery cell according to claim 4, wherein said polyether portion of 3 to 80 repeat units comprises from 3 to 25 repeat units of the —C₂H₄—O— type and from 0 to 5 total repeat units of the —C₃H₆—O—, and/or —C₄H₈—O-type.

6. The lithium-ion battery cell according to claim 4, wherein the amount of said polyether functionalized polycarboxylic acid is from about 0.05 to about 10 weight percent of said electrolyte.

7. The lithium-ion battery cell according to claim 1, wherein said polyether functionalized polycarboxylic acid is comprised of repeat units and at least 80 mole % of the repeat units are according to the formula below
—[CH(A)-C(D)B)]—
wherein:
A is H, —C(═O)— when an adjacent J is —N<, or B or mixtures thereof;
D is H, —CH₃, CH₂C(═O)—OH or a mixture thereof;
B is independently E, —C(═O)—, or G,
E is —CO₂H wherein —CO₂H means both the acid form and the —C(═O)—O⁻ form, wherein
E is optionally in a partial or full salt form,
when A is H; D is independently in each repeat unit —H, —CH₃, or —CH₂—B
when A is —C(═O)— or C(═O)—OH; D is independently in each repeat unit H or CH₃;
G is CO-J-(C_{δ}H_{2δ}—O)_{L}—(CH₂CH₂O)_{M}—R₁, where δ is 3 and/or 4, the repeat units (C_{δ}H_{2δ}O)_{L} and (CH₂CH₂O)_{M} may be in a random or block arrangement,
J is —O—, >N— when an adjacent A or B is —C(═O)—, or —N(H)—;
L is 0-20,
M is 3-60,
R₁ is a C₁-C₃₆ hydrocarbyl group;
E:G in a number ratio is from 95:5 to 25:75,
the number of repeat units in the polycarboxylic acid is from 10-5000,
when J is NH, 0-100% of the NH can react with an adjacent —CO₂H or —C(═O)—O⁻ (defined by A or B) to give a five membered imide ring as shown below:
the repeat unit being of the structure 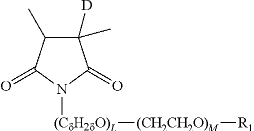
and/or with —CH₂—CO₂H or —CH₂—C(═O)—O⁻ (defined by Z) to give a five membered imide as shown below:
the repeat unit being of the structure 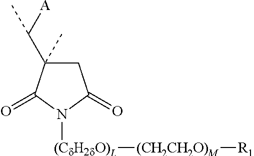
and/or two of adjacent repeat units from the polyacid might form a six membered imide ring when a nearby B is —CO₂H or —C(═O)—O⁻ and J is —N(H)— as shown below

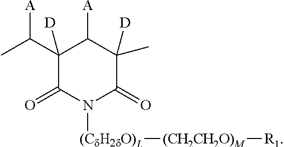

8. The lithium-ion battery cell according to claim 7, wherein at least 50 mole % of J is —O—.

9. The lithium-ion battery cell according to claim 7, wherein at least 90 mole % of J is —O—.

10. The lithium-ion battery cell according to claim 7, wherein at least 50 mole % of J is —N(H)—, —N< or combinations thereof.

11. The lithium-ion battery cell according to claim 7, wherein at least 90 mole % of J is —N(H)—, —N< or combinations thereof.

12. In a lithium-ion battery capable of multiple charging and discharging cycles, said battery comprising an anode, a cathode, a lithium-ion in electrolyte, and a separator between the anode and cathode that is porous to the lithium-ion and electrolyte, the improvement comprising utilizing a polycarboxylic acid derived from polymerizing unsaturated monomers having one or more carboxylic acid group through their carbon to carbon unsaturated and having a molecular weight from about 700 to about 350,000 g/mole wherein from about 5 to 75 mole percent of the carboxylic acid groups of said polycarboxylic acid have been converted to ester, amide, or imide linkages from reaction of the carboxylic acid groups with hydroxyl or amine terminated polyethers having from 3 to 80 repeat ether type units each to improve cycle durability.

13. The lithium-ion battery cell according to claim 1, wherein said organic electrolyte comprises one or more carbonate selected from the group of a dialkyl carbonates, a cyclic alkyl carbonates, and mixtures thereof (preferred carbonates are ethylene carbonate, propylene carbonate, diethyl carbonate, dimethyl carbonate, and/or ethyl methyl carbonate).

14. The lithium-ion battery cell according to claim 1, wherein said lithium-ion source in said electrolyte comprises at least one lithium salt selected from the group of lithium perchlorate (LiClO₄), lithium tetrafluoroborate (LiBF₄), lithium hexafluorophosphate (LiPF₆), lithium trifluoromethanesulfonate (LiCF₃SO₃), and lithium bis(trifluoromethanesulfonyl) amide (LiN(CF₃SO₂)₂, lithium bis(oxalato)borate, lithium bis(glycolato)borate, lithium bis(lactato)borate, lithium bis(malonato)borate, lithium bis(salicylate)borate, lithium (glycolato,oxalato) borate, and combinations thereof.

15. The lithium-ion battery cell according to claim 1, wherein said anode comprises carbon or silicon.

16. The lithium-ion battery cell according to claim 1, wherein the cathode is preferably a lithium metal oxide based or lithium metal phosphate based cathode optionally containing additional metals selected from the group of iron, manganese, nickel, chromium, and cobalt; such as lithium cobalt oxide (LCO), lithium nickel oxide (LNO), lithium iron phosphate (LFP), lithium manganese oxide (LMO), lithium nickel manganese cobalt oxide (NMC), and lithium nickel cobalt aluminum oxide (NCA).

17. The lithium-ion battery cell according to claim 1, wherein said polyether functionalized polycarboxylic acid is used in said battery cell in combination with at least one member of the group of vinylene carbonate, vinyl ethylene carbonate, allyl ethyl carbonate, vinyl acetate, divinyl adipate, acrylonitrile, 2-vinyl pyridine, maleic anhydride, methyl cinnamate, ally alkyl phosphite, vinyl silanes, cyclic alkyl sulphites, sulphur dioxide, polysulphides, nitrous oxide, alkyl or alkenyl nitrites and nitrates, halogenated cyclic lactones, methylchloroformate, lithium pyrocarbonate, carboxyl phenols, aromatic esters, catechol carbonate, succinimides and N-substituted succinimides.

18. A process for making the lithium-ion battery according to claim 1, including the steps of obtaining or forming
1) an anode electrode, said anode optionally having a coating made from a paste and an optional solvent,
2) a cathode electrode, said cathode optionally having a coating made from a paste and an optional solvent,
3) lithium salt, in an organic solvent, or carrier, or a polymer or combinations thereof, and
4) optionally a separator between the anode and cathode that is porous to the lithium salt and solvent or carrier, or polymer;
5) wherein a polyether functionalized polycarboxylic acid is added in at least one of the following steps
a) dissolved in said organic solvent or carrier prior to cell fabrication,
b) dissolved in the anode and/or cathode electrode coating solvent prior to electrode paste fabrication,
c) dissolved in the anode and/or cathode electrode paste prior to electrode coating, and
d) combinations thereof.
